(19) United States
(12) Patent Application Publication
(10) Pub. No.: US 2020/0381902 A1
(43) Pub. Date: Dec. 3, 2020

(54) The fulcrum plug

(71) Applicant: King D. Monroe, Petersburg, VA (US)

(72) Inventor: King D. Monroe, Petersburg, VA (US)

(21) Appl. No.: 15/732,050

(22) Filed: Sep. 11, 2017

(51) Int. Cl. H01T 13/12; H01T 13/08; F16B 21/09

(52) U.S. Cl. CPC H01T 13/12; F16B 21/09; H01T 13/08

(57) ABSTRACT

In this disclosure the inventor is disclosing his Fulcrum Spark Plug for combustion engine; when the latch is on, the handle will not turn but with a thread allowance and a clock wise turn of the handle will automatically lower the latch so that the handle can turn where all corners of the triangle shape plug are in line with the shaft the plug can be manually raised.

### BACKGROUND OF THE INVENTION

In this application the inventor is claiming all the rights to the claimed invention the Fulcrum Spark Plug the claim is on the shell of the spark plug and its applicator. The applicator enables the plug to be installed and removed without tools. The utility is on an easier and faster way to change spark plugs. The Fulcrum base, seat, or applicator locks and unlocks clockwise turn or push and turn movement. Disclosure numbers 221582 and 251931 dates March of 89 and April 1990 p.p. application Ser. No. 07/862,612 Mar. 10, 1992

The features that the utility is sought on is the latch and trip unlatch by the handle the way the plug is installed and removed by its applicator or “base” the different shapes of the shell allows the plug to pass through the threads seat and latch the plug into place. When the latch spring into place it locks the handle from turning at the right torque.

The system features are the geometric shapes and the corrugating locking system. The fulcrum plug handle was engineered to remain in the engine but can be removed.

### BRIEF SUMMARY OF THE INVENTION

The Fulcrum Plug was founded by King D. Monroe in December 1988. The idea came about years after one of the inventors duties was to change a spark plug because of a leaking head gasket. The inventor is claiming a new and useful idea consisting of the wrench, bolt, and hydraulic coupler finding a new and useful invention the Fulcrum Plug.

### BRIEF DESCRIPTION OF DRAWINGS

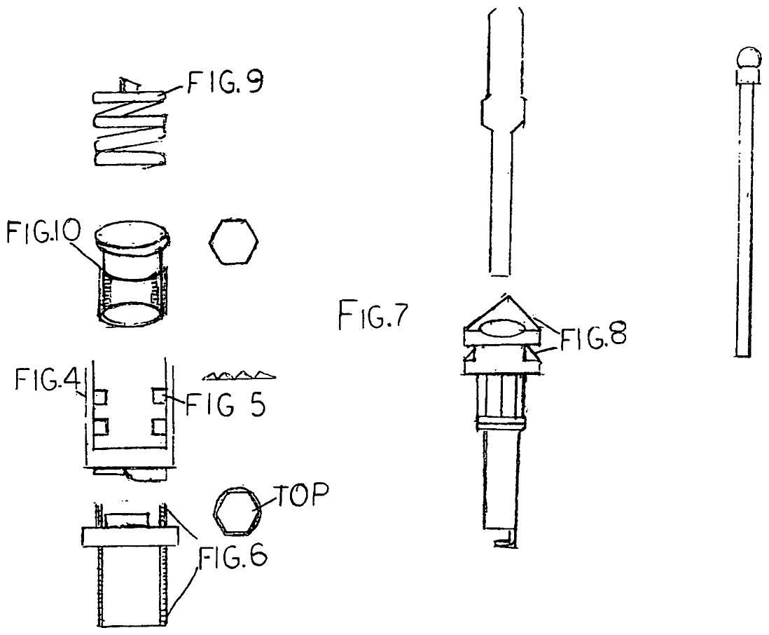

A brief description of the fulcrum shows a reworked shell that in this application the founder decided to use the triangle see FIG. 7 and the handle or reworked coupler to keep the plug seated and in place see FIG. 4.

### DETAILED DESCRIPTION OF THE INVENTION

The description of the fulcrum plug resembles a hydraulic coupler with a handle for leverage, and the part of the system that holds the plug in place. When the latch is not engaged into the handle it allows the handle to turn to where the threads ore no longer over the outermost parts of the shell this allows the plug to be removed. The fulcrum plug idea came about to make work easier for everyone. The fulcrum plug comes in two parts: the triangle shaped shell, insulator, seat cup, gasket and the plug gap. The leverage or handle is a shaft that resembles a socket wrench that has square threads near the cylinder to hold the plug down. The cylinder is grooved so that the latch and spring stays on the right path while it is operating.

### DETAILED DESCRIPTION OF THE INVENTION

FIG. 7 is the shell

FIG. 4 leverage or handle

FIG. 5 the corrugated locks (also claimed as square threads)

FIG. 6 the seat or seal and stabilizer for the fulcrum plug (connector)

FIG. 8 show the second part of the corrugated locks

FIG. 9 the spring and latch

FIG. 10 the cylinder

1. What is being claimed as new and useful and called the fulcrum plug is the handle with the corrugating shafts and the wedge on the bottom of the handle that unlatches the latches and opens up the shafts so that the plug can be removed. The fulcrum plug consist of two working parts the triangle shaped plug shell and the handle or base.
Getting the right leverage on the spark plug at the right place and time is what is patentable. The latch or latches however many is needed to keep the plug from turning is also what is new and is claimed in this request for patent.
